(19) United States
(12) Patent Application Publication
(10) Pub. No.: US 2008/0228961 A1
(43) Pub. Date: Sep. 18, 2008

(54) SYSTEM INCLUDING VIRTUAL DMA AND DRIVING METHOD THEREOF

(76) Inventor: Eui-Seung Kim, Suwon-si (KR)

Correspondence Address: F. CHAU & ASSOCIATES, LLC, 130 WOODBURY ROAD, WOODBURY, NY, 11797, US

(21) Appl. No.: 12/049,434

(22) Filed: Mar. 17, 2008

(30) Foreign Application Priority Data
Mar. 16, 2007 (KR) 10-2007-0026118

(51) Int. Cl. G06F 13/28

(52) U.S. Cl. 710/26; 710/22

(57) ABSTRACT

A system having a virtual direct memory access (DMA) and a driving method thereof, in which the system includes a central processing unit (CPU), a plurality of intellectual property units (IPs), and a virtual DMA controlling data to be transferred from a first IP unit to a second IP unit according to select information that, selects the first and second IP units of the plurality of IP units, wherein the CPU provides the select information to the virtual DMA. As an example, the first IP transfers data and the second IP receives the data.

### CROSS-REFERENCE TO RELATED APPLICATION

This U.S. non-provisional patent application claims priority under 35 U.S.C. 119 of Korean Patent Application No. 10-2007-0026118, filed on Mar. 16, 2007, the entire contents of which are hereby incorporated by reference.

### BACKGROUND OF THE INVENTION

The present disclosure relates to a semiconductor system and, more particularly, to a system including a virtual direct memory access (DMA).

A general system on a chip (SoC), as illustrated in FIG. 1A, includes a central processing unit (CPU) 110, an intellectual property (IP) 120, a memory 130, and a data bus 140. In such a system, the CPU 110 functions as the master, and the IP 120 and memory 130 function as slaves.

According to the control of the CPU 110, the IP 120 accesses the memory 130 through the data bus 140. The IP 120 performs specific functions that are difficult for the CPU 110 to process. For example, the IP 120 performs functions, such as a 3-D graphic acceleration function, a memory function, a digital signal process (DSP) function, and the like.

When requiring complex operations using data of the memory, the IP 120 directly accesses data of the memory using DMA, as illustrated in FIG. 2.

FIG. 2 is a block diagram illustrating a typical SoC system including a DMA. Referring to FIG. 2, the system includes a CPU 210, an IP 220, a memory 230, a data bus 240, and a direct memory access (DMA) 250. In such a system, the CPU 210 and the DMA 250 function as masters, and the IP 220 and memory 230 function as slaves.

According to the control of the DMA 250, the IP 220 accesses the memory 230 through the data bus 240. When the system includes the DMA 250, its configuration becomes complicated. For example, a system including an advanced. RISC machine (ARM) (not shown) is provided with additional blocks such as an arbiter, a DMA-master, and the like. Thus, even in the case of realizing a simply configured chip, the system may become complicated.

When the system does not use a DMA, however, a procedure, in which the CPU transfers data of the memory to the IP, requires a plurality of cycles as illustrated in FIG. 1B. Thus, it is necessary to minimize a bus transaction cycle required for accessing the memory data, even without using the DMA.

TABLE 1

| | CPU only System | DMA system |
|---|---|---|
| Bus | CPU only | CPU and DMA |
| | | share |
| DATA processing mode | CPU only, transferring | Only DMA |
| | data only with Software | transfers Data |
| DATA processing speed | Very slow (depends | Very fast |
| | on Software code) | |
| Disadvantages | Low speed | High cost, difficult |
| | | design |
| Advantages | Low cost | High data rate |

Table 1 represents advantages and disadvantages between a CPU only system and a DMA system with both a CPU and a DMA. The DMA system with the DMA mounted is advantageous in improving performance, while it is disadvantageous in that its fabrication cost is increased, and it is difficult to realize the DMA system.

### SUMMARY OF THE INVENTION

Exemplary embodiments of the present invention provide a system including a virtual direct memory access (DMA), which minimizes a bus transaction cycle required for accessing memory data even without using a DMA, and a driving method, of the system.

Exemplary embodiments of the present invention also provide a system that does not apply a load to a central processing unit (CPU) even without, using a DMA.

Exemplary embodiments of the present invention provide systems including: a CPU; a plurality of intellectual properties (IPs); and a virtual DMA controlling data to be transferred from a first IP to a second IP according to select information that selects the first and second IPs of the plurality of IPs, the first IP being configured to transfer data and the second IP being configured to receive the data, wherein the CPU provides the select information to the virtual DMA.

In exemplary embodiments, the first IP is a memory.

In exemplary embodiments, the virtual DMA provides a first address from the CPU to the memory.

According to exemplary embodiments, the virtual DMA generates enable signals to write data to the second. IP.

In exemplary embodiments, the memory provides data to the second IP in response to the first address signal from the virtual DMA.

According to exemplary embodiments, the virtual DMA provides the second address from the CPU to the second IP.

In exemplary embodiments, the second IP stores the data from the memory, in response to the second EN signal and the second address signal from the virtual DMA.

In exemplary embodiments, other IPs of the plurality of the IPs except for the first and second IPs are disabled.

In exemplary embodiments, the second IP includes a first-in first-out (FIFO) memory.

According to exemplary embodiments of the present invention, systems include a plurality of IPs; a CPU selecting a first IP configured to transfer data and a second IP configured to receive the data, determining a first address for accessing the first IP and a second address for accessing the second IP, and providing a third address for accessing the first IP; and a virtual DMA transferring the third address to the first IP and transferring the first and second addresses and an enable signal to the second IP to control a data transfer according to the control of the CPU.

In exemplary embodiments, the virtual DMA includes: a first register storing the first address for stalling the data transfer; a second register storing the second address for terminating the data transfer; and an address comparator comparing the third address with the first and the second addresses to output the enable signal.

According to exemplary embodiments, the address comparator outputs the enable signal that stores the data to the second IP when the third address is larger than the first address and smaller than the second, address.

In exemplary embodiments, the address comparator deactivates the enable signal that activates the virtual DMA when the third address is smaller than the first address or larger than the second address.

According to exemplar) embodiments, the data bus is connected to the plurality of IPs, the memory, and the virtual DMA.

In exemplary embodiments, at least one of the plurality of IP accesses to the memory.

In exemplary embodiments, the second IP includes a FIFO memory.

### BRIEF DESCRIPTION OF THE FIGURES

Exemplary embodiments of the present invention will be understood in more detail from the following descriptions taken in conjunction with the following drawings. The drawings illustrate exemplary embodiments of the present invention and, together with the description, serve to explain principles of the present invention. In the figures:

FIGS. 1A and 1B respectively illustrate a typical system not including a direct memory access (DMA) and a related timing diagram;

FIG. 2 is a block diagram illustrating a typical system including a DMA;

FIG. 3A is a block diagram of a system including a virtual DMA according to an exemplary embodiment of the present invention;

FIG. 3B is a block diagram illustrating a virtual DMA controller shown in FIG. 3A;

FIG. 3C is a timing diagram illustrating operation of the system including the virtual DMA according to an exemplary embodiment the present invention;

FIG. 4 is a flow chart illustrating a driving method of the system including the virtual DMA in FIG. 3A;

FIG. 5A is a block diagram of a system including a virtual DMA according to an exemplary embodiment of the present invention;

FIG. 5B is a block diagram illustrating a virtual DMA controller shown in FIG. 5A;

FIG. 6 is a timing diagram illustrating a data transferring procedure using a virtual DMA according to an exemplary embodiment of the present invention; and

FIG. 7 is a timing diagram illustrating read operation during a burst mode, using a virtual DMA according to an exemplary embodiment of the present invention.

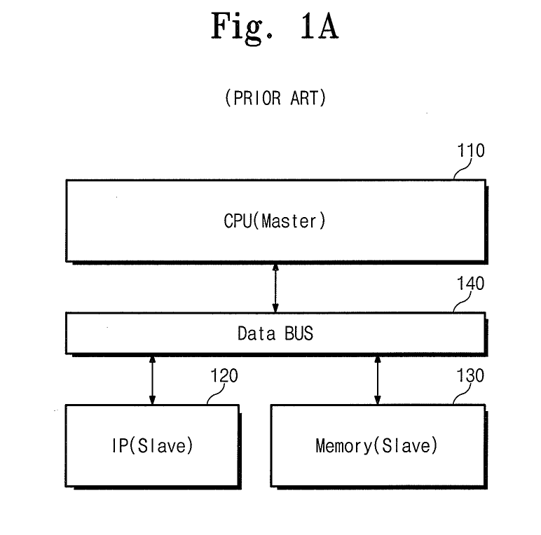

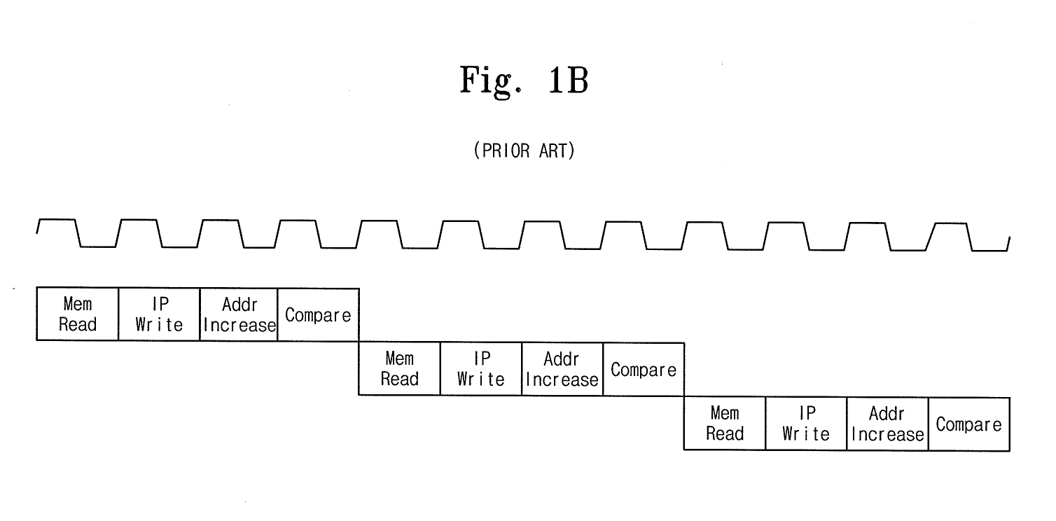

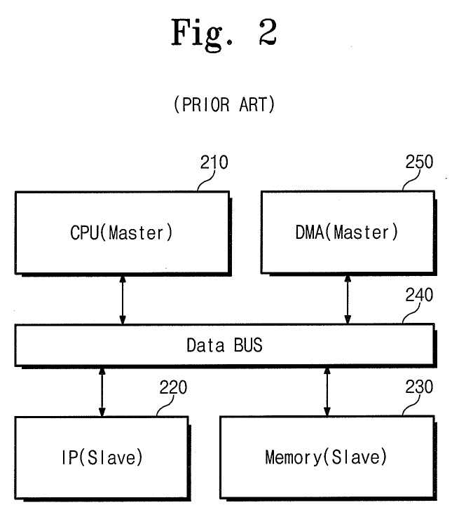

### DETAILED DESCRIPTION OF EXEMPLARY EMBODIMENTS

Exemplary embodiments of the present invention will be described, below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those of ordinary skill in the art.

Hereinafter, an exemplary embodiment of the present invention will be described with the accompanying drawings.

The new system of the exemplary embodiment of the present invention includes a central processing unit (CPU), a plurality of intellectual properties (IPs), and a virtual direct memory access (DMA) controlling data to be transferred from a first IP to a second IP according to select information that selects the first, and second IPs of the plurality of IPs, the first IP being configured to transfer data and the second IP being configured to receive the data, wherein the CPU provides the select information to the virtual DMA.

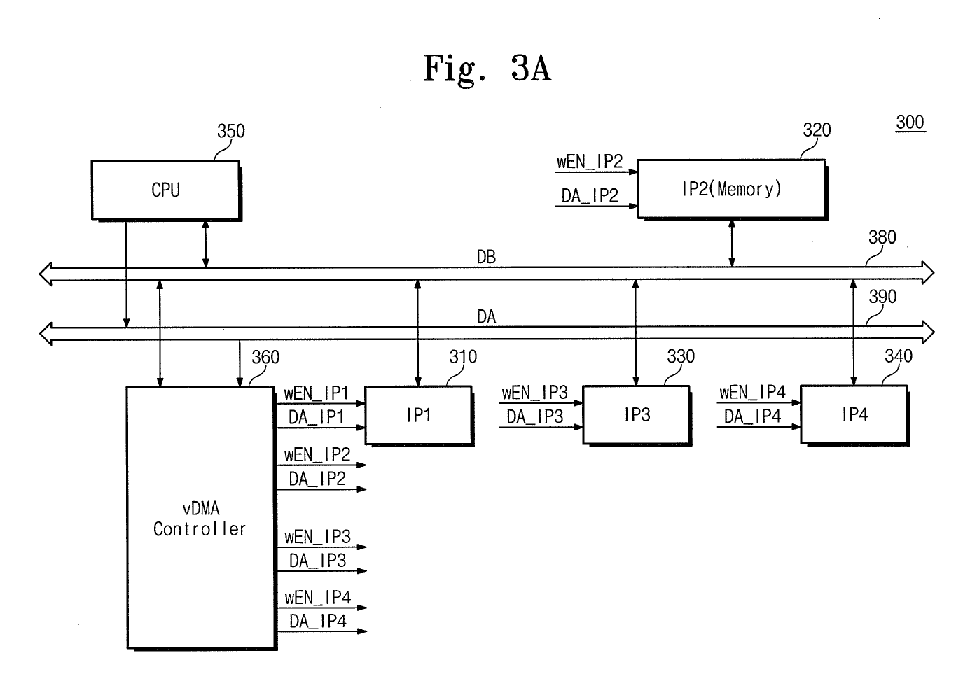

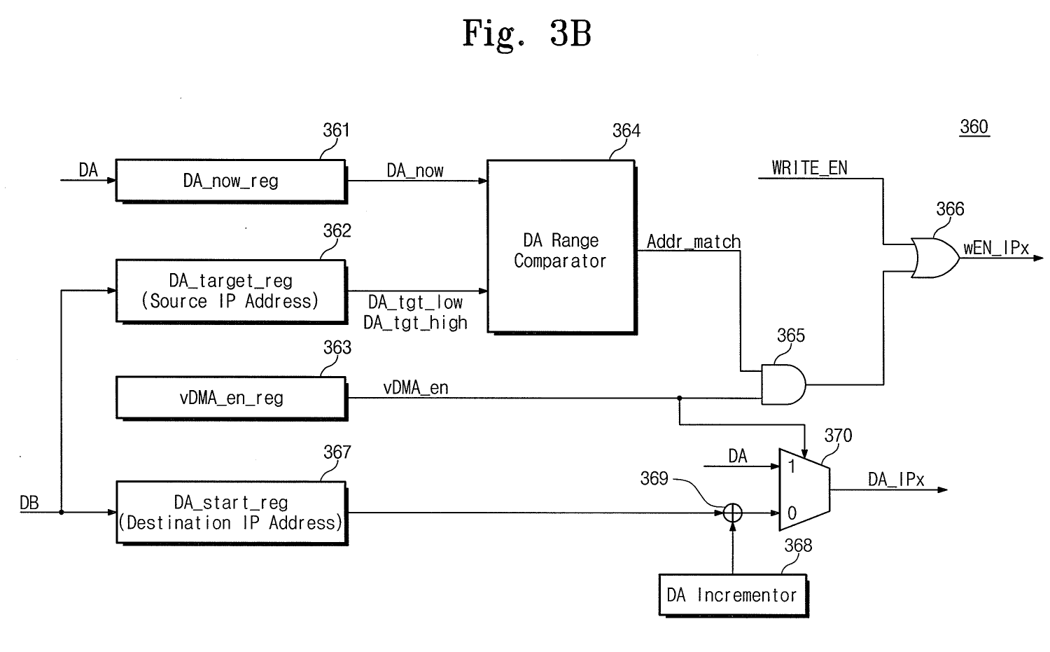

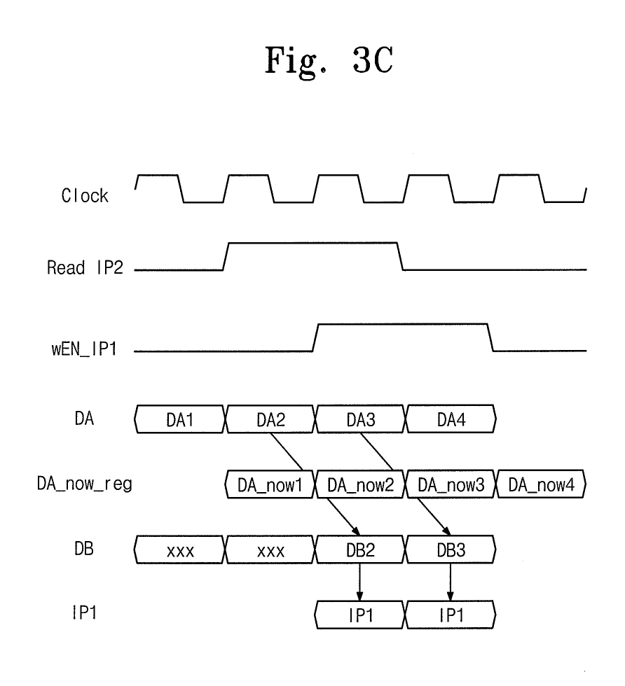

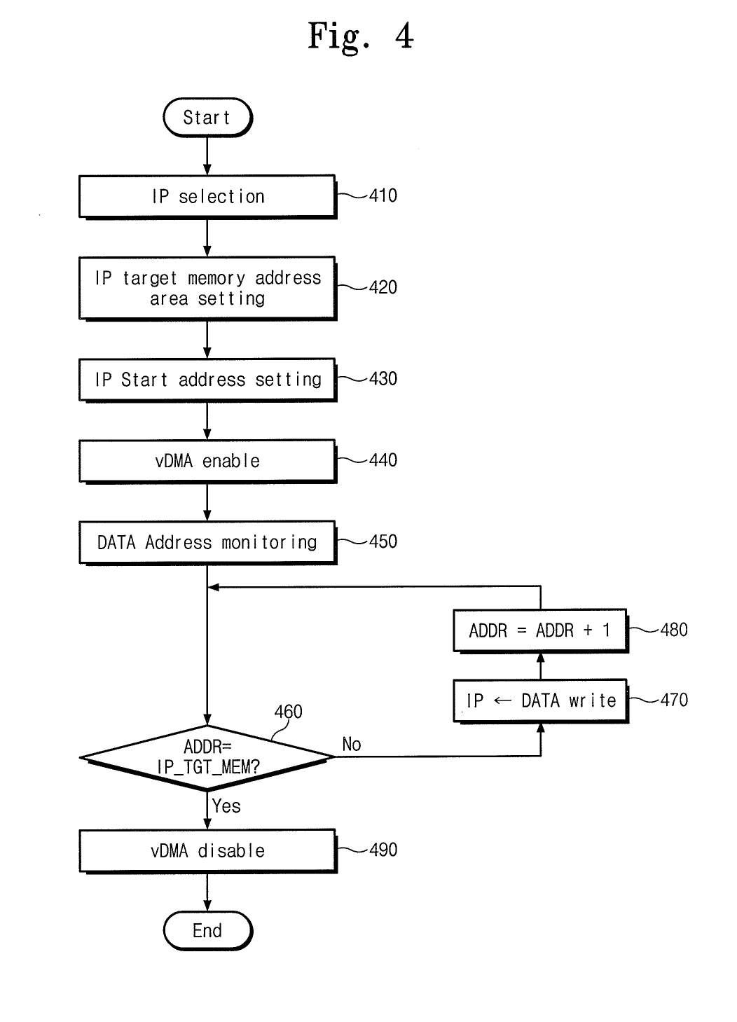

FIG. 3A is a block diagram of a system including a virtual DMA according to an exemplary embodiment of the present invention, FIG. 3B is a block diagram illustrating a virtual DMA controller in FIG. 3A, and FIG. 3C is a timing diagram illustrating operations of the system including the virtual DMA according to an exemplary embodiment of the present invention. FIG. 4 is a flow chart illustrating a driving method of the system including the virtual DMA shown in FIG. 3A.

Referring to FIG. 3A to FIG. 4, the system 300 includes a first intellectual property (IP) 310, a second IP 320, a third IP 330, a fourth IP 340, a central processing unit (CPU) 350, a virtual DMA (vDMA) controller 360, a data bus (DB) 380, and an address bus (DA) 390.

The first IP 310, the second IP 320, the third IP 330, and the fourth IP 340 are designed, to perform their own functions, respectively. For example, the first IP 310 is a 2-D graphic accelerator, the second IP 320 is a memory, the third IP 330 is a 3-D graphic accelerator, and the fourth IP 340 performs a digital signal process (DSP) function. The CPU 360 controls an overall operation of the system 300.

The virtual DMA controller 360 includes a DA_now_reg 361, a DA_target_reg 362 for containing a source IP address, a vDMA_en_reg 363, a DA_start_reg 367 for containing a destination IP address, a DA range comparator 364, an AND Gate 365, an OR Gate 366, a DA_Incrementor 368, and a multiplexer 370.

The DA_now_reg 361 delays an address DA carried on the address bus 390 by one clock to thereby generate a delayed address DA_now according to the control of the CPU 350 as illustrated in FIG. 3C, and then stores the generated, address DA_now. DA_target_reg 362 receives a range of a target address DA_tgt_now and DA_tgt_high of data to be transferred from the data bus 350 to the IP, and stores the inputted target addresses DA_tgt_low and DA_tgt_high. That is, the DA_target_reg 362 sets the range between the target low address DA_tgt_low and the target high address DA_tgt_high. The vDMA_en_reg 363 stores activation information of the virtual DMA controller 360 in response to the control of the CPU 350. The DA range comparator 364 compares the address DA_now transferred from DA_now_reg 361 with the target addresses DA_tgt_low and DA_tgt_high to output an address match signal Addr_match. The AMD gate 365 performs an AND operation on the address match signal Addr_match transferred from the DA range comparator 364 and an enable signal vDMA_en transferred from the vDMA_en_reg 363. The OR. Gate 366 performs an OR operation on an output of the AND Gate 365 and a write enable signal WRITE_EN. The DA_start_reg 367 receives a start address of a destination IP from the bus 380, and stores the start address of the destination IP. The DA_Incrementor 368 automatically increases the address each time when a write operation is performed by the virtual DMA controller 360. The adder 369 adds the address transferred from the DA_start_reg 367 and the increased address from DA_Incrementor 368. The multiplexer 370 outputs one of results of the address bus 390 and the adder 369 in response to the control of the vDMA_en_reg 363.

Referring to FIG. 3A to FIG. 4, it is assumed that the second IP 320 is a memory and the first IP 310 accesses to data stored in the second IP 320, for example.

In operation 410, the CPU 350 selects a source IP and a destination IP among IPs 310-340. That is, the source IP is the second IP 320, and the destination IP is the first IP 310 to receive memory data from the second IP 320. The CPU 350 selects a memory region required, by the first IP 310. That is, in operation 420, the DA_target_reg 362 receives the range of the target address DA_tgt_low, DA_tgt_high to be transferred, from the data bus 380 to the IP, and stores the inputted range of the target address DA_tgt_low, DA_tgt_high. Thereafter, in operation 430, a start address of the first IP 310, which is the destination IP, is set. That is, the CPU 350 stores the start, address for storing data transferred from the second IP 320 through the data bus 380, to the DA_start_reg 367.

In operation 440, the CPU 350 enables the virtual DMA controller 360. That is, the CPU 350 activates an output signal vDMA_en of the vDMA_en_reg 363. In operation 450, the CPU 350 monitors the address of the memory that the first IP 310 requires. In operation 460, the DA range comparator 364 determines whether or not the delayed address DA_now obtained by delaying the address DA by one clock falls within the target range DA_tgt_low and DA_tgt_high of the DA_target_reg 362.

If the delayed address DA_now of the DA_now_reg 361 falls within the target range DA_tgt_low and DA_tgt_high, the DA range comparator 364 activates an address match signal Addr_match. As the output signal vDMA_en of the vDMA_en_reg 363 and the address match signal Addr_match are activated, an IP write enable signal wEN_IP1 is activated. In operation 470, the first IP 310 receives the address DA_IP1 transferred from the multiplexer 370 and accesses the data DB in the data bus 380. In operation 480, the DA_Incrementor 368 increases the address and the adder 369 adds the address DA_start transferred from the DA_start_reg 367 and the increased address transferred from the DA_Incrementor 368.

If delayed address DA_now of the DA_now_reg 361 falls out of the target range DA_tgt_low and DA_tgt_high, the DA range comparator 364 deactivates the address match signal Addr_match, and the vDMA 360 continues to monitor the delayed address DA_now and to perform an infinite loop, while the output signal vDMA_en of the vDMA_en_reg 363 is being activated. Subsequently, in operation 490, the vDMA_en_reg 363 deactivates the output signal vDMA_en in response to the control of the CPU 350.

Therefore, the virtual DMA controller of an exemplary embodiment of the present invention allows the IP to access a memory or another memory rapidly. In addition, an exemplary embodiment of the present invention allows the IP to write the data carried on the data bus while the CPU is reading memory data.

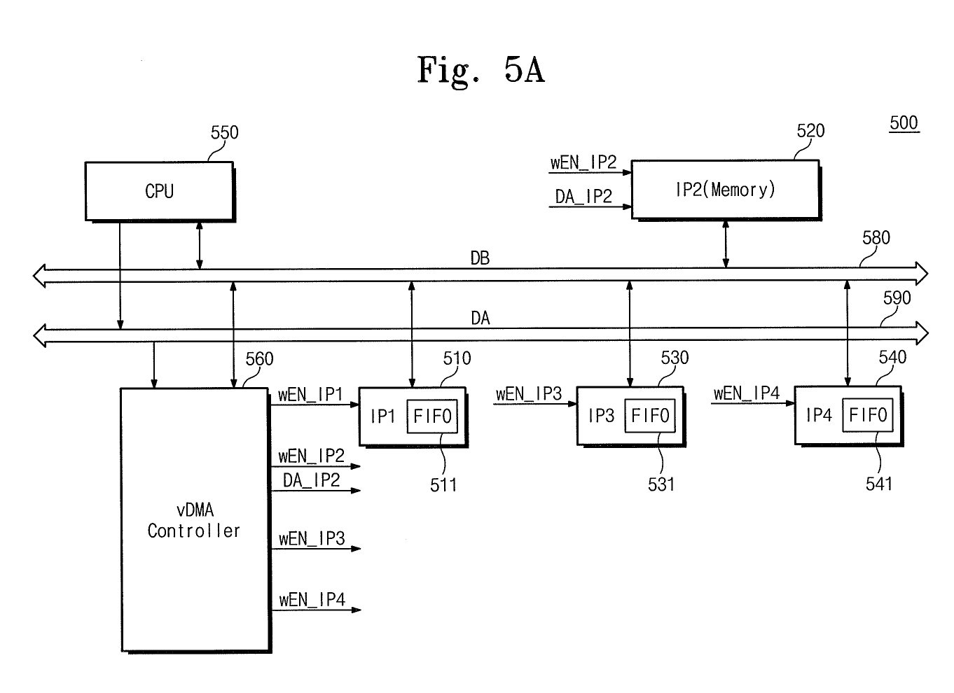

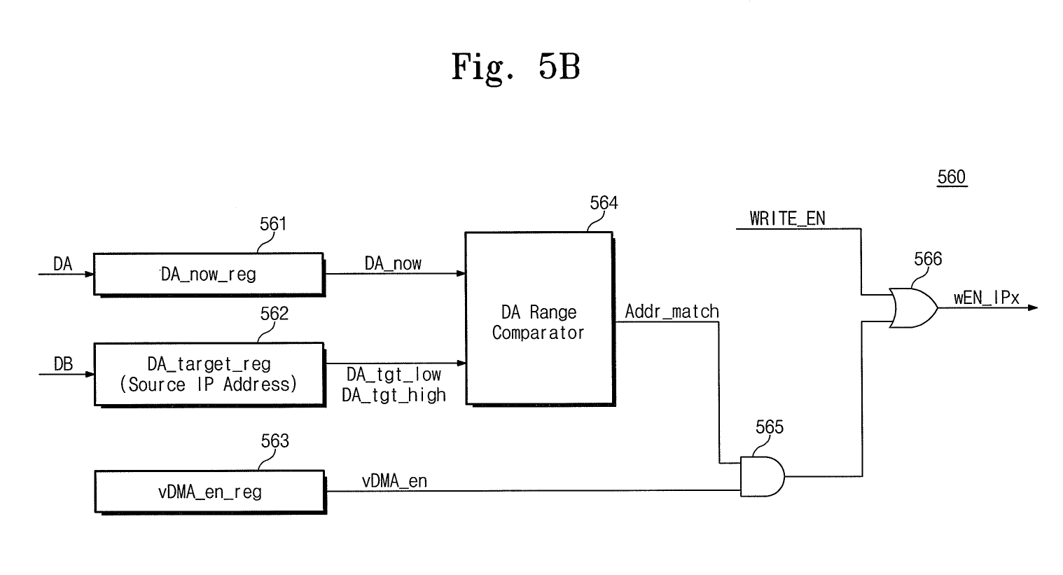

FIG. 5A is a block diagram of a system including a virtual DMA according to an exemplary embodiment of the present invention, and FIG. 5B is a block diagram illustrating a virtual DMA controller shown in FIG. 5A. The system 500 illustrated in FIGS. 5A and 5B is identical to the system 300 illustrated in FIG. 3A and FIG. 38, except for the DA_start_reg 367, the multiplexer 370, the DA_Incrementor 368, and the adder 369. Thus, a repeated description of these elements is omitted.

Referring to FIG. 5A and FIG. 5B, a first IP 510 of the system 500 includes a first First-In First-Out (FIFO) memory 511, a third IP 530 includes a second FIFO memory 531, and a fourth IP 540 includes a third FIFO memory 541.

The FIFO memories 511, 531, and 541 sequentially store data and output the data in an inputted order. Therefore, a circuit that increments the address of the data is not required due to the characteristics of the FIFO memory. That is, the DA_start_reg 367, the DA Incrementor 368, the adder 369 and the multiplexer 370, as illustrated in FIG. 3B, are not required. Therefore, the present invention is exemplarily embodied in a simpler manner, compared with the previous exemplary embodiment of FIG. 3A.

For example, it is assumed that the second IP 520 is a memory and the first IP 510 accesses to data stored in the second IP 520. According to the control of the CPU 550, the second IP 520 loads data to a data bus 580 in response to the address DA_IP2 of a virtual DMA controller 560. The first. IP 510 receives the data earned on the data bus 580 in response to the IP write enable signal, vEN_IP1 of the vDMA controller 560. That is, the first IP 510 does not require the address DA_IP1 controlled by the virtual DMA controller 560.

That is, the virtual DMA controller of the present invention is an arbiter-free DMA, that is, a DMA without an arbiter.

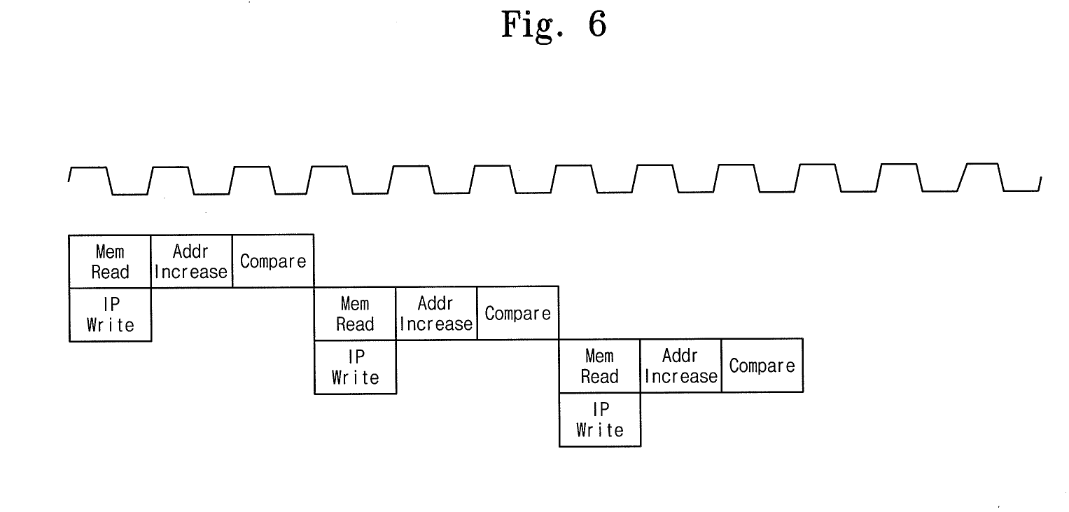

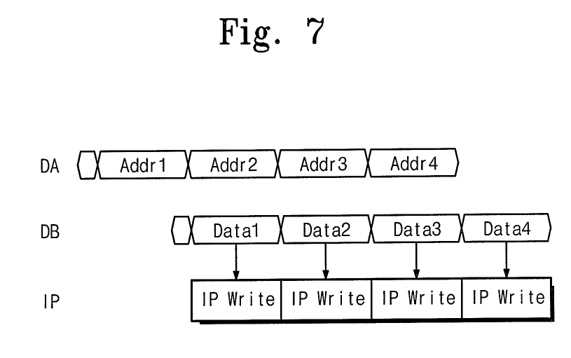

FIG. 6 is a timing diagram illustrating a data transferring procedure using a virtual DMA according to an exemplary embodiment of the present invention, and FIG. 7 is a timing diagram illustrating a read operation during a burst mode, using a virtual DMA according to an exemplary embodiment of the present invention.

Referring to FIG. 6, it is seen that the IP automatically writes data at a cycle when data are read from a memory. Referring to FIG. 7, the IP automatically writes data at the same time when data corresponding to the inputted address are outputted, during the burst mode.

The exemplary embodiment of the present invention as described above allows an IP to access a memory or another IP rapidly. The exemplary embodiment of the present invention also allows the IP to write data carried on the data bus while the CPU is reading data from the memory.

The above-disclosed exemplary embodiment is to be considered illustrative, and not restrictive, and the appended claims are intended to cover all such modifications, enhancements, and other exemplary embodiments, which fall within the true spirit and scope of the present invention. Thus, to the maximum extent allowed by law, the scope of the present invention is to be determined, by the broadest permissible interpretation of the following claims and their equivalents, and shall not be restricted or limited by the foregoing detailed description.

What is claimed is:

1. A system, comprising:
a central processing unit (CPU);
a plurality of intellectual property units (IPs); and
a virtual direct memory access (DMA) controlling data to be transferred from a first IP unit to a second IP unit according to select information that selects the first and second IP units of the plurality of IP units, the first IP unit being configured, to transfer data and the second IP unit being configured to receive the data,
wherein the CPU provides the select information to the virtual DMA.

2. The system of claim 1, wherein the first IP unit is a memory.

3. The system of claim 2, wherein the virtual DMA provides a first address signal from the CPU to the memory.

4. The system of claim 3, wherein the virtual DMA generates enable signals to write data to the second IP unit.

5. The system of claim 4, wherein the memory provides data to the second IP unit, in response to the first address signal from the virtual DMA.

6. The system of claim 5, wherein the virtual DMA provides a second address from the CPU to the second IP unit.

7. The system of claim 6, wherein the second IP unit stores the data from the memory, in response to a second EN signal and the second address signal from the virtual DMA.

8. The system of claim 1, wherein other IP units of the plurality of IP units except for the first and second IP units are disabled.

9. The system of claim 1, wherein the second IP includes a first-in first-out (FIFO) memory.

10. A system, comprising:
a plurality of intellectual property units (IPs);
a CPU selecting a first IP unit configured to transfer data and a second IP unit configured to receive the data, determining a first address for accessing the first IP unit and a second address for accessing the second IP unit, and providing a third address for accessing the first IP unit; and
a virtual DMA transferring the third address to the first IP unit and transferring the first and second addresses and an enable signal to the second IP unit to control a data, transfer according to the control of the CPU.

11. The system of claim 10, wherein the virtual DMA comprises:
a first register storing the first address for starting the data transfer;
a second register storing the second address for terminating the data transfer; and
an address comparator comparing the third address with the first and the second addresses to output the enable signal.

12. The system of claim 11, wherein the address comparator outputs the enable signal that stores the data to the second IP unit when the third address is larger than the first address and smaller than the second address.

13. The system of claim 11, wherein the address comparator deactivates the enable signal that activates the virtual DMA when the third address is smaller than the first address or larger than the second address.

14. The system of claim 10, wherein a data bus is connected to the plurality of IP units, a memory, and the virtual DMA.

15. The system of claim 10, wherein at least one of the plurality of IP units accesses a memory.

16. The system of claim 10, wherein the second IP unit comprises a FIFO memory.
